(19) United States
(12) Patent Application Publication
(10) Pub. No.: US 2026/0146589 A1
(43) Pub. Date: May 28, 2026

(54) YAW-BEARING GREASE TRAY

(71) Applicant: Inventus Holdings, LLC, Juno Beach, FL (US)

(72) Inventor: Mario PINEDA, JR., Hughson, CA (US)

(21) Appl. No.: 18/961,606

(22) Filed: Nov. 27, 2024

(51) Int. Cl. F03D 80/70

(52) U.S. Cl. CPC F03D 80/709; F05B 2260/98

(57) ABSTRACT

A yaw-bearing grease tray for a wind turbine. The yaw-bearing grease tray includes an arcuate flat band portion with an inner arcuate sidewall, an outer arcuate sidewall, a first end wall and a second end wall which are perpendicular and disposed on the arcuate flat band portion. The yaw-bearing grease tray includes a ledge formed on the first end wall to be substantially parallel to the arcuate flat band portion and a step formed at the second end wall to be substantially parallel to the arcuate flat band portion. A plurality of magnets are disposed on the arcuate flat band portion to magnetically couple with yaw-bearing bolts and yaw-bearing nuts. In one example, the yaw-bearing grease tray is translucent. In another example, a field replaceable absorbent material is sized to fit within the arcuate flat band portion.

### FIELD OF THE DISCLOSURE

The present disclosure relates generally to wind turbines and, more particularly, to devices for collecting grease emitted from the yaw-bearings and yaw-ring of a wind turbine.

### BACKGROUND

The installation of wind turbines to generate electricity continues to grow. Wind turbines include several major components. The blades are aerodynamically designed to capture wind energy and convert it into rotational motion. These blades are connected to the rotor, which spins as the wind blows. The rotor is attached to a shaft, which transfers mechanical energy to the gearbox. The gearbox increases the rotational speed to a level suitable for the generator, which converts the mechanical energy into electrical energy. The generated electricity is then transferred through the nacelle, a housing unit that contains the gearbox, generator, and control systems, down the tower to a transformer, where it is prepared for distribution. The control system and yaw mechanism ensure the turbine is positioned optimally with respect to wind direction and speed for maximum efficiency. Lastly, foundations anchor the entire structure to the ground, providing stability.

A yaw bearing in a wind turbine is a crucial component that allows the nacelle, which houses the gearbox and generator, to rotate or “yaw-” to face the wind. This rotation ensures that the turbine is always optimally aligned with the wind direction, maximizing energy capture. The yaw-bearing is positioned between the nacelle and the tower, facilitating smooth movement while supporting the weight of the nacelle and resisting various forces, such as wind loads and mechanical stress. It typically consists of large, durable metal rings with rollers or balls, allowing low-friction rotation and precise control by the yaw-drive system.

Using grease to lubricate yaw bearings ensures the yaw system operates smoothly, thus enhancing the wind turbine’s overall performance. Improper greasing or worn seals can cause excess grease to splatter inside the tower during operation. Spilled and leaked grease can cause environmental, operational, and visual concerns.

### SUMMARY OF THE INVENTION

Disclosed is a novel yaw-bearing grease tray for a wind turbine. The yaw-bearing grease tray includes an arcuate flat band portion with an inner arcuate sidewall, an outer arcuate sidewall, a first end wall and a second end wall which are perpendicular and disposed on the arcuate flat band portion. The yaw-bearing grease tray includes a ledge formed on the first end wall to be substantially parallel to the arcuate flat band portion and a step formed at the second side wall to be substantially parallel to the arcuate flat band portion. The yaw-bearing grease tray includes a plurality of magnets disposed on the arcuate flat band portion to magnetically couple with yaw-bearing bolts and yaw-bearing nuts.

One or more portions of the yaw-bearing grease tray may be formed from translucent material in separate components joined together using glue, adhesive, ultra-sonic welding or a combination of techniques. In another example, the yaw-bearing grease tray may be formed as one unified piece using additive manufacturing or injection molding. In another example, the

An optional removable arcuate-shaped absorbent material may be sized to fit within the arcuate flat band portion to capture grease.

Other features and advantages of the invention will become apparent to those skilled in the art upon review of the following detailed description, claims, and drawings.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is an example of a wind turbine deployed as part of a wind farm for electricity generation, according to the prior art;

FIG. 2 is an interior view of the nacelle of FIG. 1, illustrating the yaw-drive mechanism according to the prior art;

FIG. 3 is an enlarged interior view of FIG. 2, illustrating the major components of the yaw-drive mechanism according to the prior art;

FIG. 4 is an image of the interior of a tower under the yaw-bearing with lubricant dripping down the interior walls, according to the prior art;

FIG. 5 is a perspective view of the yaw-bearing grease tray, according to an example of the present invention;

FIG. 6 is a cross-sectional view of the yaw-bearing grease tray of FIG. 5 taken along A-A’, according to an example of the present invention;

FIG. 7 is a bottom view of the yaw-bearing grease tray of FIG. 5, according to an example of the present invention;

FIG. 8 is a series of three yaw-bearing grease trays illustrating complementary interlocking ends, according to an example of the present invention;

FIG. 9 is an arcuate-shaped absorbent material sized to fit within the arcuate flat band portion of FIG. 5 that captures the grease, according to an example of the present invention;

FIG. 10 is a bottom view of a yaw-bearing grease tray with absorbent material magnetically coupled to the yaw-bearing nut and yaw-bearing bolt, according to an example of the present invention;

FIG. 11 is a side view of the yaw-bearing grease tray with absorbent material magnetically coupled to the yaw-bearing nut and the yaw-bearing bolt of FIG. 10, according to an example of the present invention;

FIG. 12 is another side view of the yaw-bearing grease tray with absorbent material magnetically coupled to the yaw-bearing nut and yaw-bearing bolt of FIG. 10, according to an example of the present invention; and

FIG. 13 is a bottom view of a series of three yaw-bearing grease trays illustrating complementary interlocking ends with absorbent material magnetically coupled to the yaw-bearing bolt and yaw-bearing nut, according to an example of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

The terms “a” or “an”, as used herein, are defined as one or more than one. The term plurality, as used herein, is defined as two or more than two.

The term “absorbent material” means any material that soaks up oils including sponges, cotton wool, cellulose-based products, and synthetic or organic Polymers, such as: polypropylene, polyurethane, polystyrene, epoxy, calcium carbonate, magnesium carbonate, peat moss, and polypropylene.

The term “adapted to” describes the hardware, software, or a combination of hardware and software that is capable of, able to accommodate, to make, or that is suitable to carry out a given function.

The term “another”, as used herein, is defined as at least a second or more.

The term “configured to” describes hardware, software or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “grease” is a solid or semisolid lubricant. Examples of grease are lubricants formed as a dispersion of thickening agents in a liquid lubricant. Grease generally consists of a soap emulsified with mineral or vegetable oil.

The terms “including” and “having,” as used herein, are defined as comprising (i.e., open language).

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

### Overview of Major Wind Turbine Components

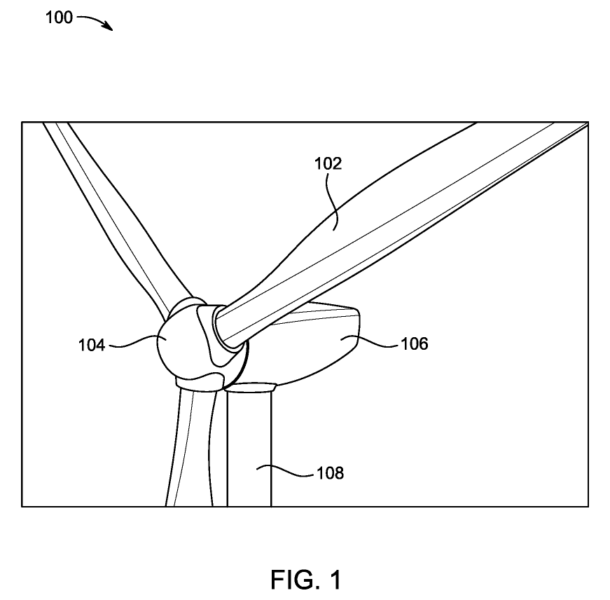

Turning to FIG. 1 is an example of a wind turbine 100 deployed as part of a wind farm for electricity generation. The blades 102 are aerodynamically designed to capture wind energy and convert it into rotational motion. These blades are connected to the rotor 104, which spins as the wind blows. The rotor is attached to a shaft, which transfers mechanical energy to the gearbox internal to the nacelle 106. The gearbox increases the rotational speed to a level suitable for the generator, which converts the mechanical energy into electrical energy. The generated electricity is then transferred through the nacelle 106, a housing unit that contains the gearbox, generator, and control systems, down tower 108 to a transformer, where it is prepared for distribution. The control system and yaw mechanism ensure the turbine is positioned optimally with respect to wind direction and speed for maximum efficiency.

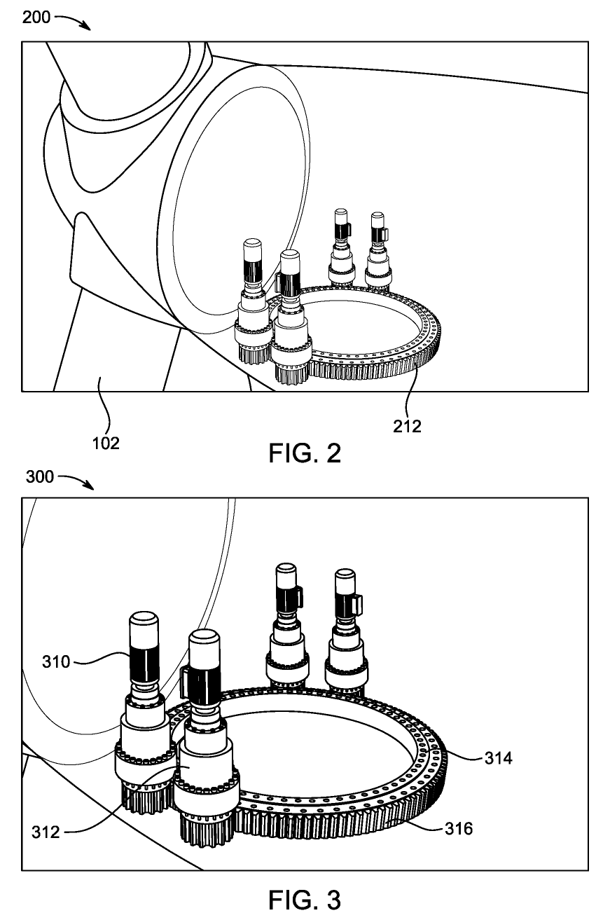

FIG. 2 is an interior view 200 of the nacelle of FIG. 1, illustrating the yaw-drive mechanism 212. The major components 300 of the yaw-drive mechanism are shown in FIG. 3. The major components include yaw-motor 310, yaw-motor with gearbox 312, yaw-bearing 314, and yaw-gear 316.

### Yaw-Bearing Grease Practices And Issues

Greasing the yaw-bearing of a wind turbine is a critical maintenance task that ensures smooth operation and extends the bearing’s lifespan. The yaw-bearing enables the turbine to rotate, or “yaw,” to face the wind, maximizing energy capture. Over time, constant movement and exposure to harsh environmental conditions can lead to significant friction and wear on the bearing. Regular greasing minimizes this wear, reduces friction, and helps prevent corrosion, allowing the turbine to rotate efficiently without placing undue stress on its components. Proper lubrication ensures the yaw system operates smoothly, thus enhancing the turbine’s overall performance.

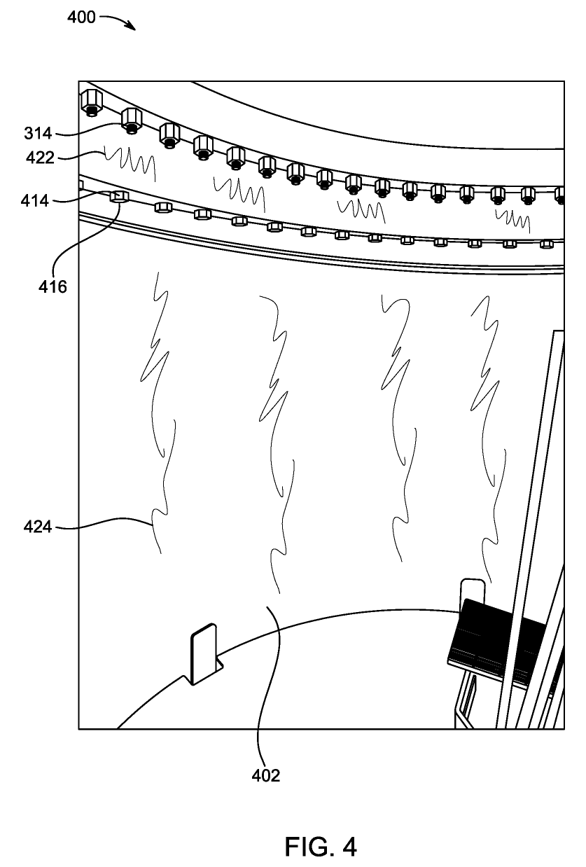

However, improper greasing practices or worn seals can cause excess grease to splatter onto the yaw deck and down the tower walls during operation. This issue is particularly common in warmer months when higher ambient temperatures cause the grease to liquefy. FIG. 4 is an image 400 of the interior wall 402 of the tower 108 with the yaw-bearing 314 and grease splatter or lubricant splatter 422, 424 dripping down the interior walls 402.

Also shown is a yaw-bearing nut 414 fastened to a yaw-bearing bolt 416, which involves threading the nut onto the bolt’s threaded shaft to secure the yaw-bearing 314. The yaw-bearing bolt 416 has external threads that match the internal threads of the yaw-bearing nut 414, allowing them to interlock as the yaw-bearing nut 414 to turn. For added security, components like lock washers or thread-locking compounds may be used to keep the nut and bolt firmly fastened under vibration or stress.

Grease splatter 422, 424 inside the tower 108 can coat critical components like electrical systems, sensors, and mechanical parts, leading to performance issues and increased maintenance requirements. In addition, it poses safety risks for maintenance personnel, as greasy surfaces can become slippery and difficult to clean. Over time, grease accumulation can contaminate other systems within the wind turbine 100, potentially causing malfunctions, especially if it reaches electrical connections or sensitive instrumentation.

### Example of Yaw-Bearing Grease Tray

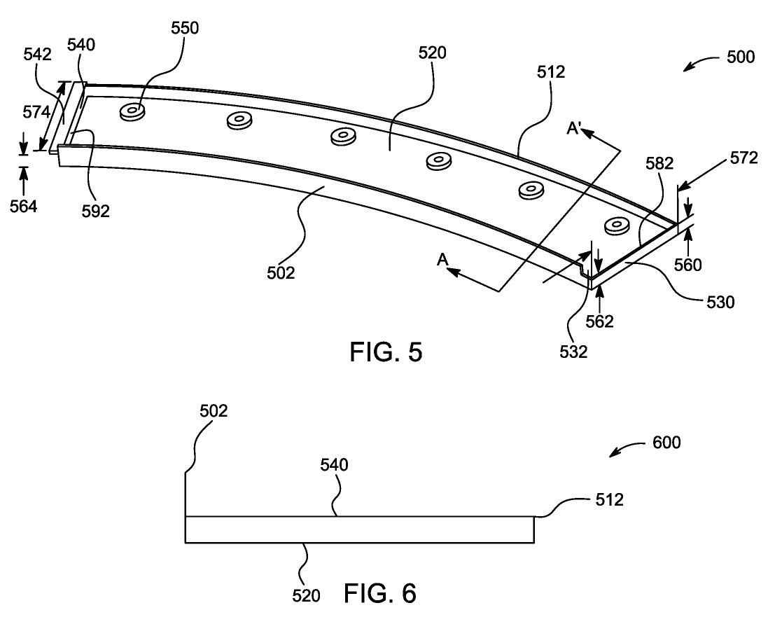

FIG. 5 illustrates a perspective view of a yaw-bearing grease tray 500 that prevents grease from splattering inside the tower 108. The yaw-bearing grease tray 500 is arcuate shaped, as shown. The yaw-bearing grease tray 500 has an inner sidewall 502 and an outer sidewall 512 separated by an arcuate flat band portion 520, wherein the height of the inner sidewall 502 is higher than the height of the outer sidewall 512. A plurality of magnets 550 is shown formed in an arcuated pattern in the arcuate flat band portion 520. In one example, the plurality of magnets 550 is substantially evenly spaced within the arcuate flat band portion 520, as shown. The magnets 550 are positioned and spaced apart to magnetically couple with the yaw-bearing-nut 414 and yaw-bearing bolt 416 of FIG. 4. The magnets can be any type of permanent magnet. Examples of permanent magnets include rare earth magnets such as samarium–cobalt and neodymium magnets.

The yaw-bearing grease tray 500 includes a first-end 530 with a first end wall 582 with a step 532. The step 532 is formed with a cutout or notch in the inner sidewall 502. The height 562 of the step 532 is approximately the same as the height 560 of the outer sidewall 560 at the first-end 530.

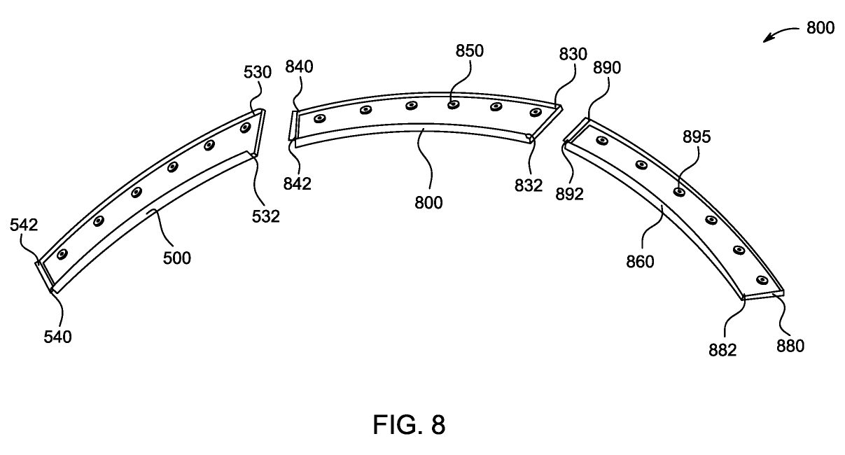

The yaw-bearing grease tray includes a second-end 540 with a second end wall 592 with a ledge 542. The ledge 542 is located on top of the second end wall 592 and is generally rectangular in shape, protruding out from the second-end 540. The ledge 542 is formed with a width 574 that fits inside the width 572 within the first end wall 582, as shown. The ledge 542 is disposed in-between and perpendicular to the inner sidewall 502 running along the second end 540 to the outer sidewall 512 at a height 564 that is approximately at the height 560 of the top of the outer sidewall 512 and the height 562 of the step 532. As further described below with reference to FIG. 8, the ledge 542 of a first yaw-bearing grease tray forms complementary interlocking ends when mechanically coupled with step 532 of a second yaw-bearing grease tray.

FIG. 6 is a cross-sectional view 600 of the yaw-bearing grease tray of FIG. 5 taken along A-A’. In this cross-sectional view, the yaw-bearing grease tray 500 is formed by the inner sidewall 502 and an outer sidewall 512 separated by an arcuate flat band portion 520 and second-end 540 in view.

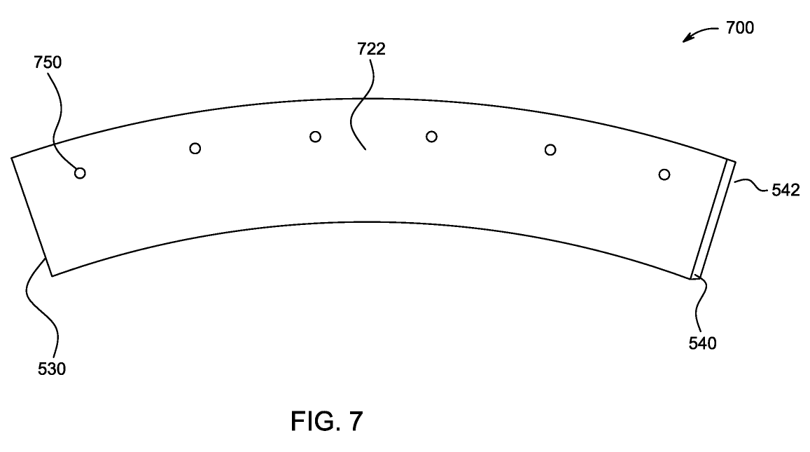

FIG. 7 is a bottom view 700 of the yaw-bearing grease tray of FIG. 5. The bottom 722 of the arcuate flat band portion 520 and a bottom 750 of the plurality of magnets 550 are shown along with the first-end 530 and the second-end 540. The ledge 542 is also visible from this bottom view.

### Example of Interlocking Multiple Yaw-Bearing Grease Trays

FIG. 8 is a series of three yaw-bearing grease trays 500, 800, 860, illustrating complementary interlocking ends. More specifically, a second yaw-bearing grease tray 800 includes a first-end 830 with a step 832 and a second-end 840 with a ledge 842. Also shown is a plurality of magnets 850. The ledge 842 of the second yaw-bearing grease tray 800, when mechanically coupled with step 532 of the first yaw-bearing grease tray 500, forms complementary interlocking ends. Also shown is the third yaw-bearing grease tray 860, which includes a first-end 880 with a step 882 and a second-end 890 with a ledge 892. Also shown is a plurality of magnets 895. The step 832 of the second yaw-bearing grease tray 800, when mechanically coupled with ledge 892 of the third yaw-bearing grease tray 860, forms complementary interlocking ends.

### Example of Optional Field-Replaceable Absorbent Material

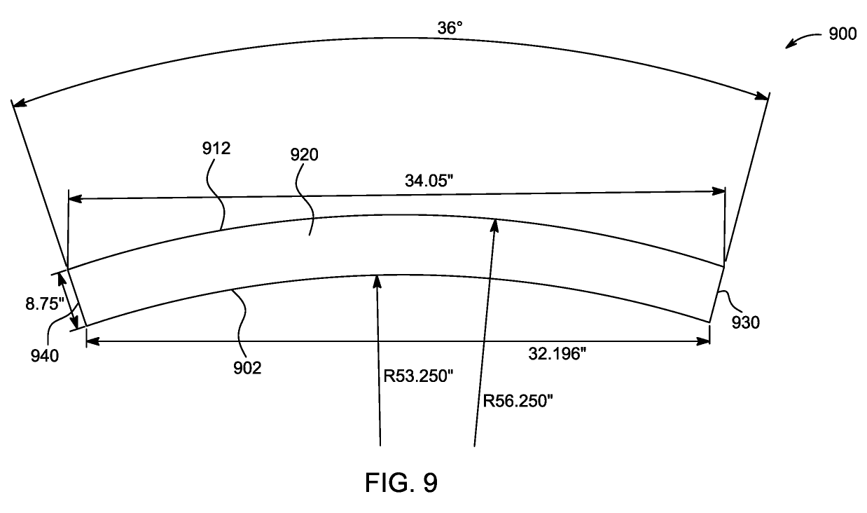

FIG. 9 is an arcuate-shaped absorbent material 900 sized to fit within the arcuate flat band portion 520 of FIG. 5. The placement of the absorbent material 900 in the arcuate flat band portion 520 is further described and shown in FIG. 11.

The arcuate-shaped absorbent material absorbs or captures the grease. One example is oil absorbent mats available from New Pig Corporation, which are cut to a desired shape. The arcuate-shaped absorbent material 900 is disposable. As described below, the arcuate-shaped absorbent material 900 may be replaced by magnetically decoupling an installed yaw-bearing grease tray and physically removing the arcuate-shaped absorbent material 900 from the arcuate flat band portion 520 of the tray. No tools are required.

In one example, the arcuate-shaped absorbent material 900 may be approximately 36 inches long with a width smaller than a width of approximately 8.75 inches of the arcuate-flat band portion 520. The actuate shape may be formed with a bottom linear measurement of 32.196 inches with a 53.250 inch radius and a top linear measurement of 34.05 inches with a 56.250 inch radius, as shown.

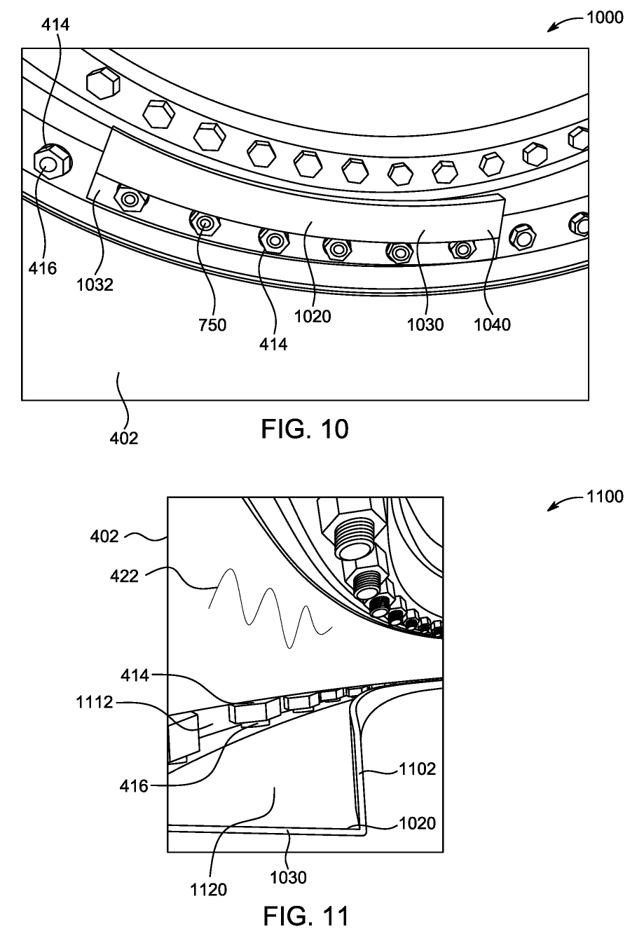

One example of the arcuate-shaped absorbent material 900 as used in an installed yaw-bearing grease tray is shown below in FIG. 10 and FIG. 11. In this example, the width of the arcuate-shaped absorbent material 900 is approximately half as wide as the arcuate-flat band portion 520 and generally disposed near the inner sidewall 502, as shown. In this example, covering only half the width of the actuate-flat band portion 520 reduces any potential inference in the magnetic coupling between the magnets 550 and the yaw-bearing nut 414.

### Example Yaw-Bearing Grease Tray Installations

FIG. 10 is a bottom view 1000 of a yaw-bearing grease tray 1020 as installed. More specifically shown is the bottom side 1030 of the yaw-bearing grease tray 1020 with absorbent material 1040 covering a portion of the arcuate flat band portion of the yaw-bearing grease tray 1020. The other portion 1032 of the arcuate flat band portion of the yaw-bearing grease tray is depicted as translucent with the bottom of magnets 750 in view. The magnets 750 are positioned along the yaw-bearing grease tray 1020 to magnetically attach to the yaw-bearing nut 414 and the yaw-bearing bolt 416.

FIG. 11 is a side view 1100 of a yaw-bearing grease tray 1020 as installed. The yaw-bearing grease tray 1020 is magnetically coupled to the yaw-bearing nut 414 and the yaw-bearing bolt 416 of FIG. 10. Also shown is the bottom side 1030 of the yaw-bearing grease tray 1020 with absorbent material 1120 covering a portion of the arcuate flat band portion of the yaw-bearing grease tray 1020. The yaw-bearing grease tray 1020 has the inner sidewall 1102 and an outer sidewall 1112 separated by an arcuate flat band portion 1020.

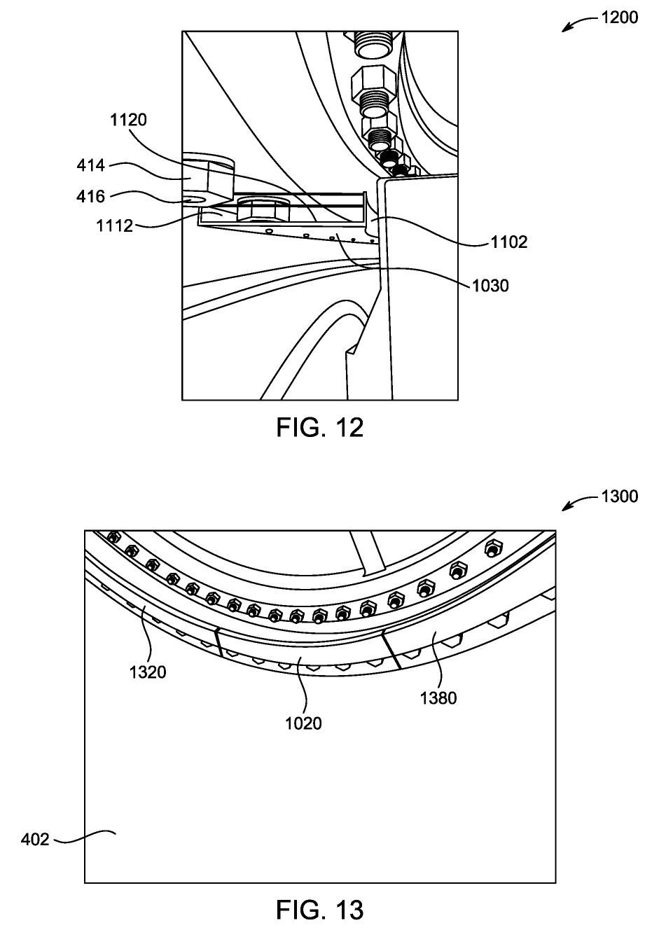

FIG. 12 is another side view 1200 of a yaw-bearing grease tray 1020 magnetically coupled to the yaw-bearing nut 414 and the yaw-bearing bolt 416 of FIG. 10. The yaw-bearing grease tray 1200 has the inner sidewall 1102 and an outer sidewall 1112 separated by an arcuate flat band portion 1020.

FIG. 13 is a bottom view 1300 of a series of three yaw-bearing grease trays 1020, 1320, 1380, illustrating complementary interlocking ends of FIG. 10.

### Fabrication Examples of Yaw-Bearing Grease Tray

In one example, the yaw-bearing grease tray 500 can be fabricated as one part using injection molding techniques or additive manufacturing such as 3-D printing. In another example, the yaw-bearing grease tray may be fabricated in individual parts. These individual parts may include one or more of the inner sidewall 502, the outer sidewall 512, and the arcuate flat band portion 520. These individual parts may be fastened together using adhesive, glue, or ultrasonically welded. The yaw-bearing grease tray may be formed as translucent so that technicians can view grease accumulation on the absorbent material from the yaw-bearing gears.

### Non-limiting Examples

Although specific examples of the subject matter have been disclosed, those having ordinary skill in the art will understand that changes can be made to the specific examples without departing from the spirit and scope of the disclosed subject matter. The scope of the disclosure is not to be restricted, therefore, to the specific examples, and it is intended that the appended claims cover any and all such applications, modifications, and examples within the scope of the present disclosure.

What is claimed is:

1. A yaw-bearing grease tray comprising:
an arcuate flat band portion with an inner arcuate sidewall, an outer arcuate sidewall, a first end wall, and a second end wall perpendicularly disposed on the arcuate flat band portion, with a ledge on the first end wall and a step at the second end wall, each of the ledge and the step are substantially parallel to the arcuate flat band portion; and
a plurality of magnets are disposed on the arcuate flat band portion.

2. The yaw-bearing grease tray of claim 1, wherein a first height of the inner arcuate sidewall is higher than a second height of the outer sidewall, and wherein the second height of the outer sidewall is equal to a third height of the first end wall and the second end wall.

3. The yaw-bearing grease tray of claim 2, wherein the step at the second end is formed by having a cutout in the inner arcuate sidewall, and the step is formed with a width and a height to create a complementary interlocking piece with a height and a width of a ledge of another yaw-bearing grease tray.

4. The yaw-bearing grease tray of claim 1, wherein the plurality of magnets is disposed approximately equidistance between each other on the arcuate flat band portion.

5. The yaw-bearing grease tray of claim 1, further comprises
a removable arcuate-shaped absorbent material sized to fit within the arcuate flat band portion to capture grease.

6. The yaw-bearing grease tray of claim 1, wherein the arcuate flat band portion, the inner arcuate sidewall, the outer arcuate sidewall, the first end wall, and the second end wall are formed from translucent material.

7. The yaw-bearing grease tray of claim 6, wherein the ledge and the step are formed from translucent material.

8. The yaw-bearing grease tray of claim 1, wherein the arcuate flat band portion, the inner arcuate sidewall, and the outer arcuate sidewall are formed as separate components and attached to the arcuate flat band portion using one of glue, adhesive, ultra-sonic welding, or a combination of both.

9. The yaw-bearing grease tray of claim 8, wherein the ledge and the step are formed as separate components and attached to the arcuate flat band portion using one of glue, adhesive, ultra-sonic welding, or a combination of both.

10. A yaw-bearing grease tray system comprising:
a first yaw-bearing grease tray formed with an arcuate flat band portion with an inner arcuate sidewall, an outer arcuate sidewall, a first end wall, and a second end wall perpendicular disposed on the arcuate flat band portion with a ledge on the first end wall and a step at the second end wall, each of the ledge and the step are substantially parallel to the arcuate flat band portion and a plurality of magnets are disposed on the arcuate flat band portion;
a second yaw-bearing grease tray formed with an arcuate flat band portion with an inner arcuate sidewall, an outer arcuate sidewall, a first end wall, and a second end wall perpendicular disposed on the arcuate flat band portion with a ledge and a step at the second end wall, each of the ledge and the step are substantially parallel to the arcuate flat band portion and a plurality of magnets are disposed on the arcuate flat band portion; and
wherein the ledge of the first yaw-bearing grease tray and the step of the second yaw-bearing grease tray form a complementary interlocking piece.

11. The yaw-bearing grease tray system of claim 10, wherein a height of the inner arcuate sidewall is higher than a height of the outer sidewall for each of the first yaw-bearing grease tray and the second yaw-bearing grease tray.

12. The yaw-bearing grease tray system of claim 11, wherein the step at the second end of the second yaw-bearing grease tray is formed by having a cutout in the inner arcuate sidewall, and the step is formed with a width and a height to create a complementary interlocking piece with a height and a width of a ledge of the first yaw-bearing grease tray.

13. The yaw-bearing grease tray system of claim 10, wherein the plurality of magnets on the first yaw-bearing grease tray and the second yaw-bearing grease tray is disposed approximately equidistance between each other on the arcuate flat band portion.

14. The yaw-bearing grease tray system of claim 10, further comprises
at least one removable arcuate-shaped absorbent material sized to fit within the arcuate flat band portion of the first yaw-bearing grease tray and the second yaw-bearing grease tray for capturing grease.

15. The yaw-bearing grease tray system of claim 10, wherein the arcuate flat band portion, the inner arcuate sidewall, and the outer arcuate sidewall of the first yaw-bearing grease tray and the second yaw-bearing grease tray are formed from translucent material.

16. The yaw-bearing grease tray system of claim 15, wherein the ledge and the step of both the first yaw-bearing grease tray and the second yaw-bearing grease tray are formed from translucent material.

17. The yaw-bearing grease tray system of claim 10, wherein the arcuate flat band portion, the inner arcuate sidewall, and the outer arcuate sidewall of the first yaw-bearing grease tray and the second yaw-bearing grease tray are formed as separate components and attached to the arcuate flat band portion using one of glue, adhesive, ultra-sonic welding, or a combination of both.

18. The yaw-bearing grease tray system of claim 17, wherein the ledge and the step of the first yaw-bearing grease tray and the second yaw-bearing grease tray are formed as separate components and attached to the arcuate flat band portion using one of glue, adhesive, ultra-sonic welding, or a combination of both.
